(19) United States
(12) Patent Application Publication
(10) Pub. No.: US 2017/0255955 A1
(43) Pub. Date: Sep. 7, 2017

(54) System and Method For Storing A Digital Receipt On A Cloud For Allowing A Vendor To Reward A Purchaser For Obtaining the Digital Receipt

(71) Applicants: JAVIER ENRIQUE CASTANEDA GOMEZ, BOGOTA DC (CO); JOHN ALEXANDER CASTANEDA ORTEGA, SAN CRISTOBAL (VZ)

(72) Inventors: JAVIER ENRIQUE CASTANEDA GOMEZ, BOGOTA DC (CO); JOHN ALEXANDER CASTANEDA ORTEGA, SAN CRISTOBAL (VZ)

(21) Appl. No.: 14/951,257

(22) Filed: Nov. 24, 2015

Related U.S. Application Data
(60) Provisional application No. 62/055,466, filed on Sep. 25, 2014.

(51) Int. Cl. G06Q 30/02; G06Q 20/04; G06Q 50/00

(52) U.S. Cl. CPC G06Q 30/0214; G06Q 50/01; G06Q 20/0453

(57) ABSTRACT

A system and method for storing a digital receipt on a cloud for allowing a vendor to reward a purchaser for obtaining the digital receipt. The vendor and purchaser complete a transaction. The vendor offers to sell a digital receipt of the transaction to the purchaser for a fee. The digital receipt can be useful to the purchaser for enhanced tracking of financial records. Upon accepting the digital receipt, the purchaser registers personal information through a Public Unique Code (PUC). The PUC is unique to the purchaser and contains various information that help the vendor track purchases and provide benefits to the purchaser. The purchaser receives a benefit from the vendor by publishing the PUC on a social network website. A plurality of potential purchasers can view the PUC on the social network website. Additional benefits are provided by the vendor when new transactions occur.

### CROSS-REFERENCE TO RELATED APPLICATIONS

The present application claims the priority benefit of U.S. Provisional Patent Application 62/055,466 filed 2014 Sep. 25 by the same inventor. The entire contents of the provisional application is incorporated herein by reference.

### BACKGROUND

It is known that a receipt is a written acknowledgment that a specified article or payment has been received for a transaction between vendor and a purchaser. Generally, it is obligatory for a vendor to provide a receipt to a purchaser confirming the details of a transaction. The receipt forms a financial record that the purchaser can subsequently use for various purposes that are relevant to the transaction.

The inventor was aware that receipts were valuable records for both the purchaser and the vendor. In most cases the vendor provided the receipt, but in some cases the receipt was generated by the purchaser, as in the case of goods returned to a store for a refund. In another example of receipt transactions, if the vendor was required to collect a tax from the purchaser, the amount collected would be included on the receipt and the amount would be deemed to have been collected on behalf of the relevant government tax authority.

The inventor also realized that receipts were easily lost, since they usually came in the form of a small strip of paper. It also dawned on the inventor that myriad transactions occurred annually, with each transaction resulting in a separate paper receipt being generated. Most of these paper receipts were discarded almost immediately, or lost due to their small size. This created much waste of paper and ink, which increased costs for the vendor.

The inventor was aware that electronic documents the development of computer networks has made it so that in most cases it is much more convenient to distribute electronic documents than printed ones. The improvements in electronic display technologies mean that in most cases it is possible to view documents on screen instead of printing them (thus saving paper and the space required to store the printed copies). The inventor realized that receipts could be stored as electronic documents, and thus provide many of the same advantages.

The inventor also recognized a need to generate further revenue for the vendor. The inventor was aware that purchasers could benefit from the digital format of receipts because the digital format facilitates financial recordkeeping, including, expense accounting, tax preparations, routing to accounting and taxation departments, and real-time analysis of cash-flow and budgeting. The inventor guessed that many purchasers would pay a fee for the service of receiving a digital receipt.

Through past experiences, the inventor knew that social media sites have proliferated through the Internet. These sites allow a user to connect with “friends” or contacts. The users associated with these social network website sites can also broadcast messages from their social network websites instantaneously. For the most part, these messages include personal communications. Typically, the proliferation of social network website sites presents an opportunity for vendors to market their products or services using the social media sites.

The inventor recognized that registering a number of purchasers to post the products or services on the social media site would be effective because social media networks focus on the relationships and links between individuals or groups of individuals. The purchasers would have built a relationship with potential purchasers on the social media site, and thus trust for the product or service would be already present. The inventor figured that the vendor would award the purchaser with discounts and other benefits for publishing information about the transactions on the social network website.

The inventor noticed that benefits, such as discounts, coupons, and monetary funds served as a great incentive for purchasers. A vendor, who had the products or services for sale, could provide these benefits with little financial loss if transactions occurred at a heavy volume and new purchasers were conducting transactions. The inventor quickly recognized that commercial transactions were commonly conducted by potential purchasers after viewing other purchasers and their buying habits, reviews, and experiences with vendors. By combining benefits with social network websites, the vendor could record information about the consumers and deliver the benefits more readily. The purchaser could conduct financial transactions more efficiently with digital receipts. The potential purchasers could be exposed to the vendor through a known and trusted purchaser.

Electronic documentation for transactions and vendor supplied benefits have been used for generating fees and receiving discounts in the past, yet none with the present characteristics of the present invention. See patent numbers: U.S. Pat. No. 6,341,353; U.S. 20100274685; U.S. 20060053056 and U.S. Pat. No. 7,797,192.

For the foregoing reasons, there is a need for a system and method for storing a digital receipt on a cloud for allowing a vendor to reward a purchaser for obtaining the digital receipt.

### SUMMARY

The present invention is directed to a system and method for storing a digital receipt on a cloud for allowing a vendor to reward a purchaser for obtaining the digital receipt. The system and method allows a vendor and a purchaser to electronically document a transaction on a digital receipt and post the transaction on a social network website for viewing and access by potential purchasers. In one embodiment, the vendor and purchaser complete a transaction for an item or service. The vendor may then offer to sell a digital receipt of the transaction to the purchaser for a fee. If the purchaser accepts the digital receipt, the digital receipt is transmitted to a network cloud, which can be viewed and accessed by the purchaser. The digital receipt can be useful to the purchaser for enhanced tracking of financial records. Thus, the purchaser has incentive to pay the fee to the vendor for the digital receipt.

Upon accepting the digital receipt, the purchaser registers personal information through a Public Unique Code (PUC). The PUC is unique to the purchaser and may contain various information that help the vendor track purchases and provide benefits to the purchaser. For example, the transaction between the purchaser and the vendor includes transaction information, such as items or services purchased, costs, discounts received, and vendor location. This transaction information is stored in the PUC. The PUC is accessible in a downloadable software app, which can be downloaded by the purchaser and maintained by the vendor. The purchaser receives a benefit from the vendor by publishing the PUC on a social network website. A plurality of potential purchasers can view the PUC on the social network website, and thus be made aware of the transaction information, including the digital receipt. The potential purchasers can also present the PUC to the vendor to receive benefits upon completion of a new transaction. The purchaser may also receive benefits from the vendor when the potential purchasers perform a new transaction with the vendor and present the PUC.

As a result, the vendor benefits when the purchaser publishes the PUC (and all the related transaction information) on the social network website. This is because the potential purchasers are made aware of the vendor and the transaction information. The potential purchasers are made aware of the items and services offered by the vendor. The potential purchasers also receive benefits from the vendor by presenting (through print or digital display) the PUC to the vendor while performing a new transaction. Finally, the purchaser gains by receiving a benefit every time a potential purchaser presents the PUC to the vendor and performs a new transaction.

One objective of the present invention is that the purchaser has the option of receiving a digital receipt, which facilitates financial recordkeeping, including, expense accounting, tax preparations, routing to accounting and taxation departments, and real-time analysis of cash-flow and budgeting.

Another objective is to provide a source of revenue for a vendor by enabling the vendor to charge a fee to the purchaser for providing and routing the digital receipt.

Another objective is to provide a vendor with commercial advantages by distributing the digital receipt by reducing costs, gathering accurate purchaser information, building brand awareness, and developing targeted marketing strategies.

Another objective is to store the digital receipt in a network cloud that is accessible to the purchaser.

Another objective is to reduce paper and ink consumption by replacing paper receipts with digital receipts.

Yet another objective is to provide an easy to download app for the purchaser that enables the purchaser to download and register with the vendor.

Yet another objective is to provide a vendor with additional information about the purchaser through the PUC, which includes contact information, purchase history, and past receipts in digital format.

Yet another objective is to expose a plurality of potential purchasers to the item or service provided by the vendor through a social network website.

Yet another objective is to utilize a PUC to provide benefits for both potential purchasers and the purchaser who initially made the transaction with the vendor.

Yet another objective is to enable the purchaser to accumulate benefits over a duration every time potential purchasers perform a transaction with the PUC on the social network website.

### DRAWINGS

These and other features, aspects, and advantages of the present invention will become better understood with regard to the following description, appended claims, and drawings where:

FIG. 1 is a block diagram of a system for storing a digital receipt on a cloud for allowing a vendor to reward a purchaser for obtaining the digital receipt;

FIGS. 2A and 2B are flowchart diagrams of a method for storing a digital receipt on a cloud for allowing a vendor to reward a purchaser for obtaining the digital receipt; and

FIG. 3 is a block diagram depicting an exemplary client/server system which may be used by an exemplary web-enabled/networked embodiment of the present invention.

### DESCRIPTION

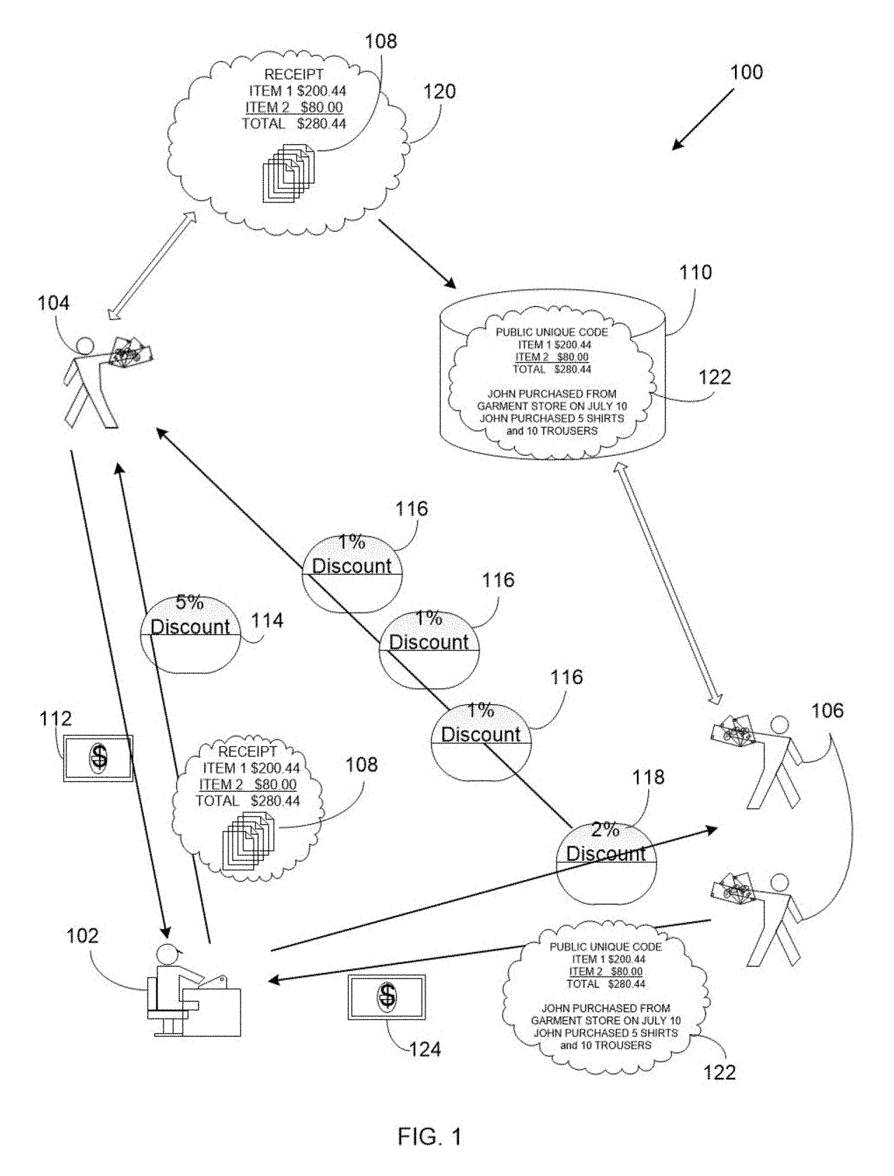

One embodiment, referenced in FIGS. 1-3, illustrates a system 100 and method 200 for storing a digital receipt 108 on a cloud 120 for allowing a vendor 102 to reward a purchaser 104 for obtaining the digital receipt 108. The system 100 and method 200 allows a vendor 102 and a purchaser 104 to electronically document a transaction on a digital receipt 108 and post the transaction on a social network website 110 for viewing and access by potential purchasers 106.

In one embodiment, the vendor 102 and purchaser 104 complete a transaction for an item or service. The vendor 102 may then offer to sell a digital receipt 108 of the transaction to the purchaser 104 for a fee 112. If the purchaser 104 accepts the digital receipt 108, the digital receipt 108 is transmitted to a network cloud 120, which can be viewed and accessed by the purchaser 104. The digital receipt 108 can be useful to the purchaser 104 for enhanced tracking of financial records. Thus, the purchaser 104 has incentive to pay the fee 112 to the vendor 102 for the digital receipt 108.

Upon accepting the digital receipt 108, the purchaser 104 registers personal information through a Public Unique Code (PUC) 122. The PUC 122 is unique to the purchaser 104 and may contain various information that help the vendor 102 track purchases and provide a benefit 114 to the purchaser 104. For example, the PUC 122 comprises transaction information, such as items or services purchased, costs, discounts received, and vendor location. This transaction information is stored in the PUC 122 for the vendor 102 to better track shopping habits, and preferred types of benefit 114 for the purchaser 104.

In some embodiments, the PUC 122 may be accessible in a downloadable software app, which can be downloaded by the purchaser 104 and maintained by the vendor 102. The purchaser 104 receives the benefit 114 from the vendor 102 by publishing the PUC 122 on a social network website 110. From the social network website 110, a plurality of potential purchasers 106 can view the PUC 122, and thus be made aware of the transaction information, including the digital receipt 108. In some embodiments, the potential purchasers 106 can present the PUC 122 to the vendor 102 to receive a potential purchaser benefit 118 upon completion of a new transaction 124. The purchaser 104 may also receive at least one cumulative benefit 116 from the vendor 102 when the potential purchasers 106 perform the new transaction 124 with the vendor 102 and present the PUC 122.

As a result, the vendor 102 receives good publicity when the purchaser 104 publishes the PUC 122 (and all the related transaction information) on the social network website 110. This is because the potential purchasers 106 are made aware of the vendor 102 and the transaction information. Additionally, the potential purchasers 106 are made aware of the items and services offered by the vendor 102. The potential purchasers 106 also receive potential purchaser benefits 118 from the vendor 102 by presenting (through print or digital display) the PUC 122 to the vendor 102 while performing a new transaction 124. Finally, the purchaser 104 gains by receiving at least one cumulative benefit 116 every time a potential purchaser 104 presents the PUC 122 to the vendor 102 and performs a new transaction 124.

FIG. 1 illustrates a system 100 for storing a digital receipt 108 on a cloud 120 for allowing a vendor 102 to reward a purchaser 104 for obtaining the digital receipt 108. The system 100 initiates when a transaction for an item or service occurs between a vendor 102 and a purchaser 104. The vendor 102 offers the purchaser 104 the option of receiving a paper receipt or a digital receipt 108 for a fee 112. The purchaser 104 can choose to receive a paper receipt, or a digital receipt 108 at the time of the transaction, and through a point-of-sale device. In one embodiment, the digital receipt 108 is automatically generated at the point-of-sale terminal for the purchaser 104 and transmitted to a cloud network 120. The system 100 allows the purchaser 104 to decide whether to accept the digital receipt 108 from the vendor 102. However, if the purchaser 104 chooses the paper receipt, the system 100 and method 200 terminates.

Those skilled in the art, in light of the present teachings, will recognize that the digital receipt 108 can be useful for the purchaser 104 to maintain and organize financial records. For example, the digital receipt 108 can be used in place of paper receipts for expense accounting, for tax preparation, for routing to accounting and taxation departments, and for real-time analysis of cash-flow and budgeting. Thus, the purchaser 104 has many incentives to pay the fee 112 for choosing the digital receipt 108 over the paper receipt. The digital receipt 108 may be stored in a network cloud 120 that is accessible to the purchaser 104. However in alternative embodiments, the digital receipt 108 may be stored in a remote server, a database, and a portable data storage device. It is also significant to note that the vendor 102 gains advantages through the digital receipt 108 by reducing costs, gathering accurate purchaser information, building brand awareness, and developing targeted marketing strategies.

Similarly, the vendor 102 receives commercial gain by receiving the fee 112 for providing the digital receipt 108 to the purchaser 104. The fee 112 may include a set amount or a percentage of the total purchase price. Those skilled in the art will recognize that technology enables the transfer of the digital receipt 108 to occur almost instantaneously and with minimal costs to the vendor 102. The environment also profits by reducing paper and ink cost of traditional paper receipts.

If the purchaser 104 accepts the digital receipt 108, the purchaser 104 must create a Public Unique Code (PUC) 122 by registering personal information and transaction information. The transaction information may include, without limitation, items or services purchased, costs, discounts received, and vendor location. The personal information, transaction information, contact information, and transaction history of the purchaser 104 are all stored in the PUC 122. The PUC 122 is unique to the purchaser 104 and the transaction. The vendor 102 can use the PUC 122 to identify purchasing habits of the purchaser 104, communicate with the purchaser 104, and provide a benefit 114 to the purchaser 104. The PUC 122 can also be used by the purchaser 104 to inform the vendor 102 about recent purchases to obtain the benefits 114.

In some embodiments, the PUC 122 may be accessible by the purchaser 104 and the vendor 102 in a downloadable software app, which can be downloaded by the purchaser 104 and maintained by the vendor 102. In one embodiment, the PUC 122 is downloadable on a smart phone. However, the PUC 122 may be accessed through other virtual means, including, without limitation, portable storage devices, cd's, tapes, and copying.

In some embodiments, the system 100 allows the purchaser 104 to display the PUC 122, which includes the transaction information, on a social network website 110. The social network website 110 may include, without limitation, a set of related web pages typically served from a single web domain. The social network website 110 can be a set of social relations that link people through the World Wide Web. Those skilled in the art will recognize that social network websites 110 focus on the relationships and links between individuals or groups of individuals. The purchaser 104 may have built a relationship with a plurality of potential purchasers 106 on the social network website 110, and thus trust for the item or service is present. By posting the PUC 122 on the social network website 110, the purchaser 104 makes it known that the transaction was completed, and also the vendor 102 and transaction information is viewable on the social network website 110. The vendor 102 can take advantage of the purchaser's 104 connections on the social network website 110 by providing the benefit 114 to the purchaser 104 for posting the PUC 122 on the social network website 110. The benefit 114 may include, without limitation, a discount, coupon, monetary amount, or bonus that is redeemable upon conducting a transaction with the vendor 102.

In one embodiment, the purchaser 104 may have a network of friends and family, who may be potential purchasers 106 that are interested in daily affairs of the purchaser 104, including transactions conducted by the purchaser 104. For example, without limitation, the potential purchasers 106 may be interested in learning more about a restaurant visited by the purchaser 104. The purchaser 104 posts the PUC 122, which includes the restaurant items ordered and the prices paid. In one alternative embodiment, the purchaser 104 can post a review of the restaurant, or the review can be integrated into the PUC 122. In another example, the vendor 102 posts a PUC 122 on the social network website 110 for a telephone service company. The purchaser's 104 details about the service offered and costs are displayed. For example, the monthly payments and the allotted minutes for use of the phone are viewable on the social network website 110. The potential purchasers 106 can then make comparative analysis with their phone service company for the possibility of switching services.

After viewing the PUC 122 on the social network website 110, the potential purchasers 106 can parlay the PUC 122 into potential purchaser benefits 118 from the vendor 102. In some embodiments, the potential purchasers 106 can print the PUC 122 or digitally display the PUC 122 on their smart phone. In either case, the PUC 122 can be used to obtain the potential purchaser benefit 118 while performing a new transaction 124 with the vendor 102. Thus, when the potential purchaser 104 presents the PUC 122 and purchases an item or service, the potential purchaser 104 receives a potential purchaser benefit 118.

Additionally, the purchaser 104 receives at least one cumulative benefit 116 when the potential purchasers 104 presents the PUC 122 and perform a new transaction 124. In this manner, the purchaser 104 can accumulate rewards over a duration every time the potential purchasers 106 perform a new transaction 124 and present the PUC 122 to the vendor 102. The purchaser 104 may thus receive at least one cumulative benefit 114 that continues with each successive transaction by the plurality of potential purchasers 106. In one embodiment, both the potential purchaser benefit 118 and the at least one cumulative benefit 116, may include, without limitation, a discount, coupon, monetary amount, or bonus that is redeemable upon conducting a transaction with the vendor 102.

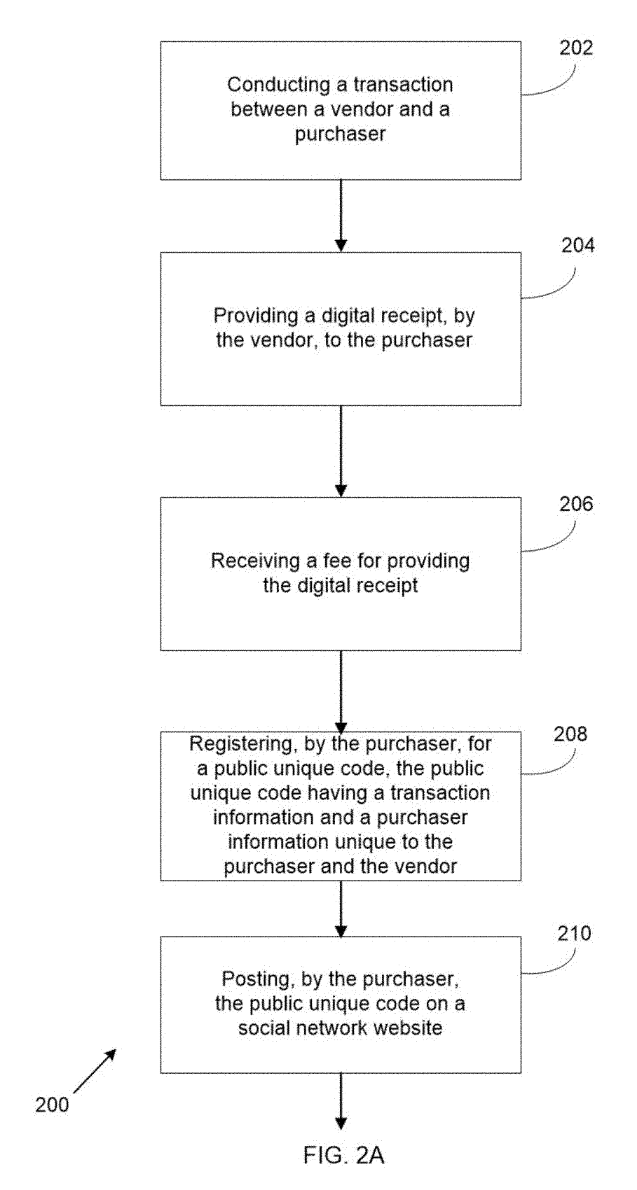

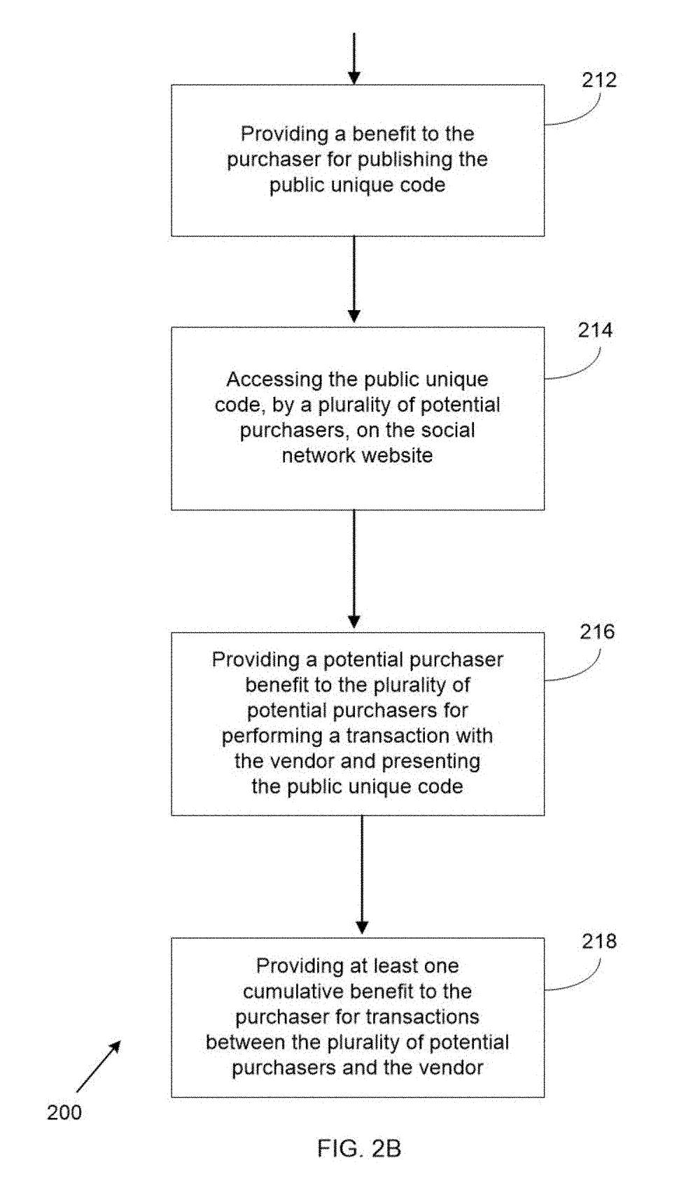

FIG. 2 illustrates a flowchart diagram of an exemplary method 200 for storing a digital receipt 108 on a cloud 120 for allowing a vendor 102 to reward a purchaser 104 for obtaining the digital receipt 108. The method 200 allows a vendor 102 and a purchaser 104 to electronically document a transaction on a digital receipt 108 and post the transaction on a social network website 110 for viewing and access by potential purchasers 106. In some embodiments, the method 200 may include an initial Step 202 of conducting a transaction between a vendor 102 and a purchaser 104. The transaction may include a sale of an item or service. The method 200 initiates when the transaction for the item or service occurs between a vendor 102 and a purchaser 104. The method 200 may further comprise a Step 204 of providing a digital receipt 108, by the vendor 102, to the purchaser 104. The vendor 102 offers the purchaser 104 the option of receiving a paper receipt or a digital receipt 108 for a fee 112. The purchaser 104 can choose to receive the paper receipt, or the digital receipt 108. If the purchaser 104 chooses the paper receipt, the method 200 terminates.

A Step 206 includes receiving a fee 112 for providing the digital receipt 108. The digital receipt 108 can be useful for the purchaser 104 to maintain and organize financial records. For example, the digital receipt 108 can then be used in place of paper receipts for expense accounting, for tax preparation, for routing to accounting and taxation departments, and for real-time analysis of cash-flow and budgeting. Thus, the purchaser 104 has many incentives to pay the fee 112 for choosing the digital receipt 108 over the paper receipt. The fee 112 can be a set amount or a percentage of the total transaction price.

In some embodiments, a Step 208 comprises registering, by the purchaser 104, for a public unique code 122, the public unique code 122 having a transaction information and a purchaser information unique to the purchaser 104 and the vendor 102. If the purchaser 104 accepts the digital receipt 108, the purchaser 104 must create the PUC 122 by registering personal information and transaction information. The transaction information may include, without limitation, items or services purchased, costs, discounts received, and vendor location. The personal information, transaction information, contact information, and transaction history of the purchaser 104 are all stored in the PUC 122.

A Step 210 includes posting, by the purchaser 104, the public unique code 122 on a social network website 110. The purchaser 104 to display the PUC 122, including the transaction information, on a social network website 110. The social network website 110 can be a set of social relations that link the purchaser 104 and a plurality of potential purchasers 106 through the World Wide Web. In some embodiments, a Step 212 may include providing a benefit 114 to the purchaser 104 for publishing the public unique code 122. The vendor 102 recognizes the potential of increasing exposure to the item or service. The vendor 102 can receive an advantage by awarding a benefit 114 to the purchaser 104 for posting information about the transaction in the form of the PUC 122. A Step 214 comprises accessing the public unique code 122, by a plurality of potential purchasers 106, on the social network website 110. In one embodiment, the purchaser 104 may have a network of friends and family, who may be potential purchasers 106 that are interested in daily affairs of the purchaser 104, including transactions conducted by the purchaser 104. The potential purchasers 106 view the PUC 122, which includes the transaction information, and potentially do business with the respective vendor 102.

A Step 216 includes providing a potential purchaser benefit 118 to the plurality of potential purchasers 106 for performing a transaction with the vendor 102 and presenting the public unique code 122. After viewing the PUC 122 on the social network website 110, the potential purchasers 106 can parlay the PUC 122 into various discounts and bonuses from the vendor 102. In some embodiments, the potential purchasers 106 can print the PUC 122 or digitally display the PUC 122 on their smart phone. In either case, the PUC 122 can be used to obtain the potential purchaser benefit 118 while performing a new transaction 124 with the vendor 102.

A final Step 218 includes providing at least one cumulative benefit 114 to the purchaser 104 for transactions between the plurality of potential purchasers 106 and the vendor 102. The original purchaser 104 can accumulate awards and bonuses from the vendor 102 over a duration every time any of the potential purchasers 106 performs a new transaction 124 and presents the PUC 122 to the vendor 102. The purchaser 104 may thus receive at least one cumulative benefit 116 that continues with each successive new transaction 124 by the potential purchasers 106.

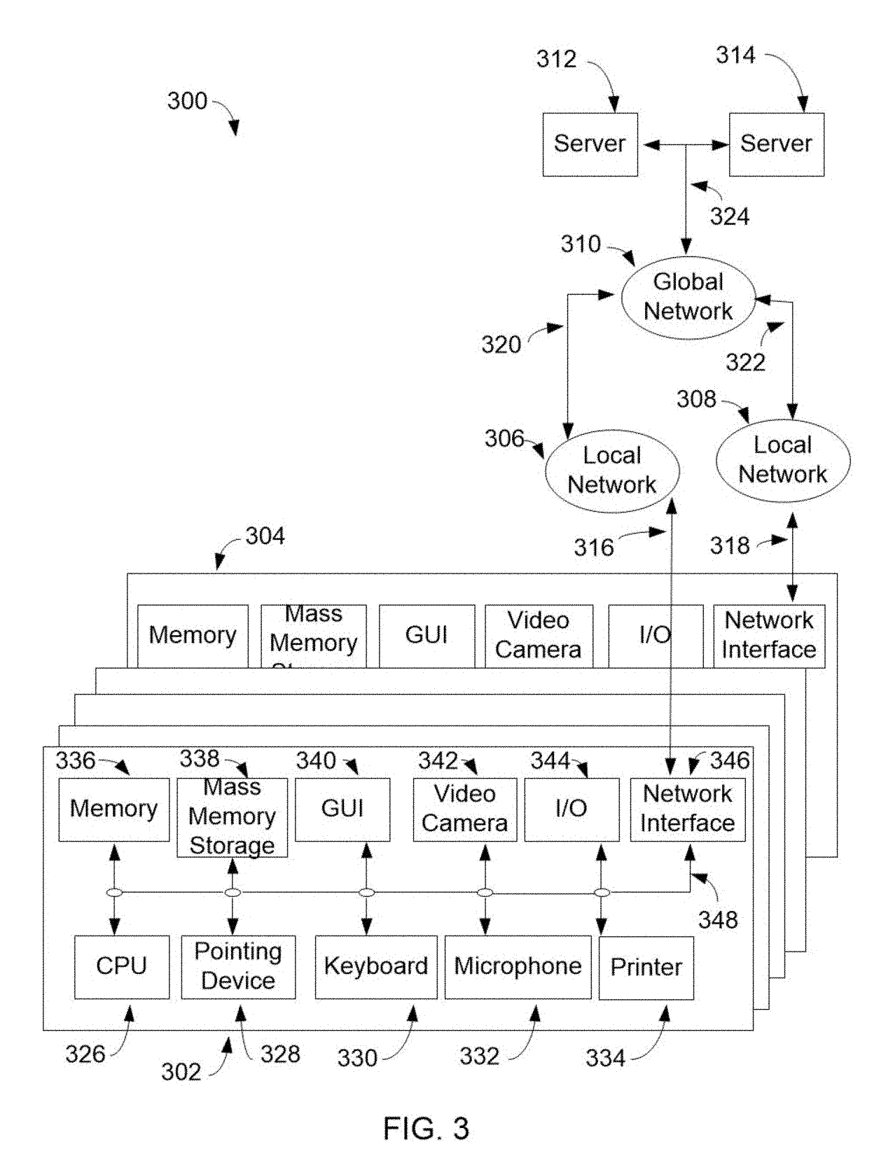

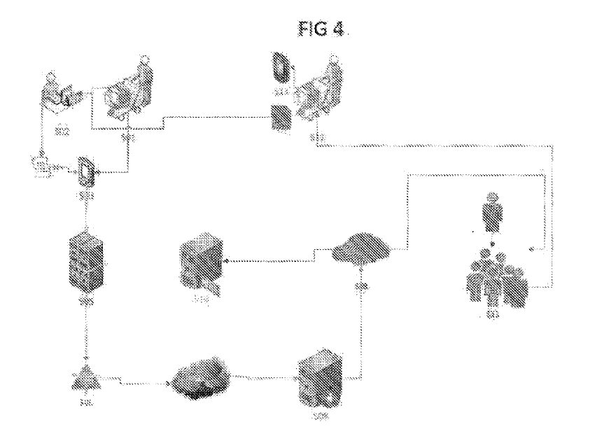

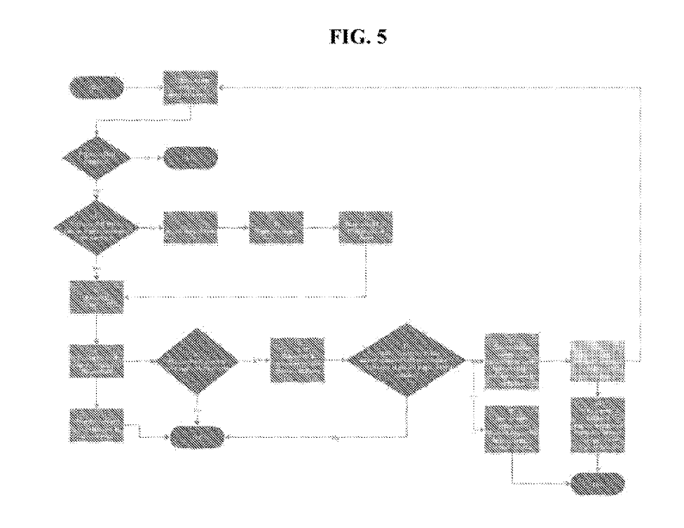

FIG. 3 is a block diagram depicting an exemplary client/server system which may be used by an exemplary web-enabled/networked embodiment of the present invention.

A communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the system could be used between a supplier and a wholesale purchaser to incentivize large purchases by providing values through a wholesale networking site. Accordingly, the scope should be determined not by the embodiments illustrated, but by the appended claims and their legal equivalents.

What is claimed is:

1. One or more computer storage media storing computer-usable instructions, that when used by one or more computing devices, cause the one or more computing devices to perform a method for storing a digital receipt on a cloud for allowing a vendor to reward a purchaser for obtaining the digital receipt, the method comprising:
conducting a transaction between a vendor and a purchaser;
providing a digital receipt, by the vendor, to the purchaser;
receiving a fee for providing the digital receipt;
registering, by the purchaser, for a public unique code, the public unique code having a transaction information and a purchaser information unique to the purchaser and the vendor;
posting, by the purchaser, the public unique code on a social network website;
providing a benefit to the purchaser for publishing the public unique code;
accessing the public unique code, by a plurality of potential purchasers, on the social network website;
providing a potential purchaser benefit to the plurality of potential purchasers for performing a transaction with the vendor and presenting the public unique code; and
providing at least one cumulative benefit to the purchaser for transactions between the plurality of potential purchasers and the vendor.

2. The method of claim 1, wherein a software application operates the method.

3. The method of claim 2, wherein the software application includes a personal database, a products and services database, and a purchases database.

4. The method of claim 1, wherein the step of providing a digital receipt, by the vendor, to the purchaser further includes providing the purchaser the option of receiving a digital receipt or a paper receipt.

5. The method of claim 1, wherein the digital receipt is stored in a network cloud.

6. The method of claim 1, wherein the transaction information is a purchase price and a vendor location.

7. The method of claim 1, wherein the benefit is a discount for an item or service.

8. The method of claim 1, wherein the step of registering for the public unique code further includes downloading a software app.

9. A system for a vendor for storing a digital receipt on a cloud for allowing a vendor to reward a purchaser for obtaining the digital receipt, the system comprises:
a transaction performed between a vendor and a purchaser;
a digital receipt that provides acknowledgment of the transaction, the digital receipt storable in a network cloud for accessibility by the purchaser;
a public unique code that provides a unique identification of the vendor and the transaction;
a social network website for publishing the public unique code;
a benefit provided from the vendor to the purchaser for publishing the public unique code on the social network website;
a plurality of potential purchasers for viewing the public unique code through the social network website; and
a potential purchaser benefit provided from the vendor to the plurality of potential purchasers for performing a new transaction with the vendor and presenting the public unique code to the vendor.

10. The system of claim 9, wherein the purchaser has the option of receiving the digital receipt or receiving a paper receipt.

11. The system of claim 9, wherein the benefit is a discount for an item or service.

12. The system of claim 9, wherein the vendor receives at least one cumulative benefit for every new transaction performed by the plurality of potential purchasers.

13. The system of claim 9, wherein the purchaser downloads a software app to register the public unique code.

14. A non-transitory program storage device readable by a machine tangibly embodying a program of instructions executable by the machine to perform a method for storing a digital receipt on a cloud for allowing a vendor to reward a purchaser for obtaining the digital receipt, the storage device comprises:
(a) a device selected from the group consisting of a computer, a tablet or a smart phone;
(b) a computer code for conducting a transaction between a vendor and a purchaser that is installed on the device;
(c) a computer code for providing a digital receipt, by the vendor, to the purchaser;
(d) a computer code for receiving a fee for providing the digital receipt;
(e) a computer code for registering, by the purchaser, for a public unique code, the public unique code having a transaction information and a purchaser information unique to the purchaser and the vendor;
(f) a computer code for posting, by the purchaser, the public unique code on a social network website;
(g) a computer code for providing a benefit to the purchaser for publishing the public unique code;
(h) a computer code for accessing the public unique code, by a plurality of potential purchasers, on the social network website;
(i) a computer code for providing a potential purchaser benefit to the plurality of potential purchasers for performing a transaction with the vendor and presenting the public unique code; and
(j) a computer code for providing at least one cumulative benefit to the purchaser for transactions between the plurality of potential purchasers and the vendor.

15. The method of claim 14, wherein the step of providing a digital receipt, by the vendor, to the purchaser further includes providing the purchaser the option of receiving a digital receipt or a paper receipt.

16. The method of claim 14, wherein the digital receipt is stored in a network cloud.

17. The method of claim 14, wherein the transaction information is a purchase price and a vendor location.

18. The method of claim 14, wherein the benefit is a discount for an item or service.

19. The method of claim 14, wherein the step of registering for the public unique code further includes downloading a software app.
